(19) United States
(12) Patent Application Publication
(10) Pub. No.: US 2014/0259090 A1
(43) Pub. Date: Sep. 11, 2014

(54) Storage Object Distribution System with Dynamic Policy Controls

(71) Applicant: FUTUREWEI TECHNOLOGIES, INC., Plano, TX (US)

(72) Inventors: Wyllys Ingersoll, Ashburn, VA (US); James Hughes, Palo Alto, CA (US)

(73) Assignee: FutureWei Technologies, Inc., Plano, TX (US)

(21) Appl. No.: 13/791,254

(22) Filed: Mar. 8, 2013

(51) Int. Cl. H04L 29/06

(52) U.S. Cl. CPC H04L 63/20
USPC 726/1

(57) ABSTRACT

System and methods for storage object distribution using dynamic policy controls are provided. An embodiment method of updating a policy on an endpoint node includes receiving, from a key management server, an update to be applied to the policy on the endpoint node, updating, on the endpoint node, the policy without modifying applications on the endpoint node, and enforcing, on the endpoint node, the policy as updated when one of the applications requests an object stored on the endpoint node. In an embodiment, the method further includes storing, at the endpoint node, an object received from the key management server to appear as a file in a file system structure.

### TECHNICAL FIELD

The present disclosure relates to data security and storage management and, in particular embodiments, to systems and methods for key management and object distribution in a cloud storage security environment.

### BACKGROUND

Cloud storage is a model of networked online storage where data is stored in virtualized pools of storage, which are generally hosted by third parties. Hosting companies operate large data centers, and people who require their data to be hosted buy or lease storage capacity from them. The data center operators, in the background, virtualize the resources according to the requirements of the customer and expose them as storage pools, which the customers can themselves use to store files or data objects. Physically, the resource may span across multiple servers.

Cloud storage services may be accessed through a web service application programming interface (API), a cloud storage gateway, or through a Web-based user interface.

In a massively scalable network of computer systems, such as the “cloud” computing infrastructure, the distribution of objects and the policies associated with those objects needs to be managed between the management node and the endpoint nodes. This is to ensure that, among other things, the sensitive data remains secure. To do so, cloud computing systems and cloud storage often involves encryption systems, encryption keys, and the like.

### SUMMARY

An embodiment method of updating a policy on an endpoint node includes receiving, from a key management server, an update to be applied to the policy on the endpoint node, updating, on the endpoint node, the policy without modifying applications on the endpoint node; and enforcing, on the endpoint node, the policy as updated when one of the applications requests an object stored on the endpoint node.

An embodiment method of updating a policy on a plurality of endpoint nodes includes generating, at a key management server, an update to be applied to the policy on each of the plurality of endpoint nodes, sending, by the key management server, the update to each of the plurality of endpoint nodes, and instructing, by the key management server, each of the plurality of endpoint nodes to apply the update to the policy when received.

An embodiment endpoint node includes a memory storing objects therein, at least one of the objects being a policy, an application in communication with the memory, and a key file system module in communication with the memory and the application, the key file system updating the policy in response to a request from a key management server without modifying the application and enforcing the policy as updated when the application requests access to one of the objects stored in the memory corresponding to the policy.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an embodiment file system with a key management server and a plurality of endpoint nodes communicating through a network;

FIG. 2 illustrates one of the endpoint nodes of FIG. 1 in further detail;

FIG. 3 illustrates objects stored in a memory by the key file system module such that the objects appear to the endpoint node and applications as a file in a file system structure;

FIG. 4 illustrates an embodiment method of updating a policy on the endpoint node of FIG. 1;

FIG. 5 illustrates an embodiment method of updating a policy on a plurality of the endpoint nodes of FIG. 1; and

FIG. 6 is a block diagram illustrating a computing platform that may be used for implementing, for example, the devices and methods described herein, in accordance with an embodiment.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present disclosure provides many applicable inventive concepts that can be embodied in a wide variety of specific contexts. The specific embodiments discussed are merely illustrative and do not limit the scope of the disclosure.

The present disclosure will be described with respect to preferred embodiments in a specific context, namely a cloud computing environment. The concepts in the disclosure may also apply, however, to other types of computing environments.

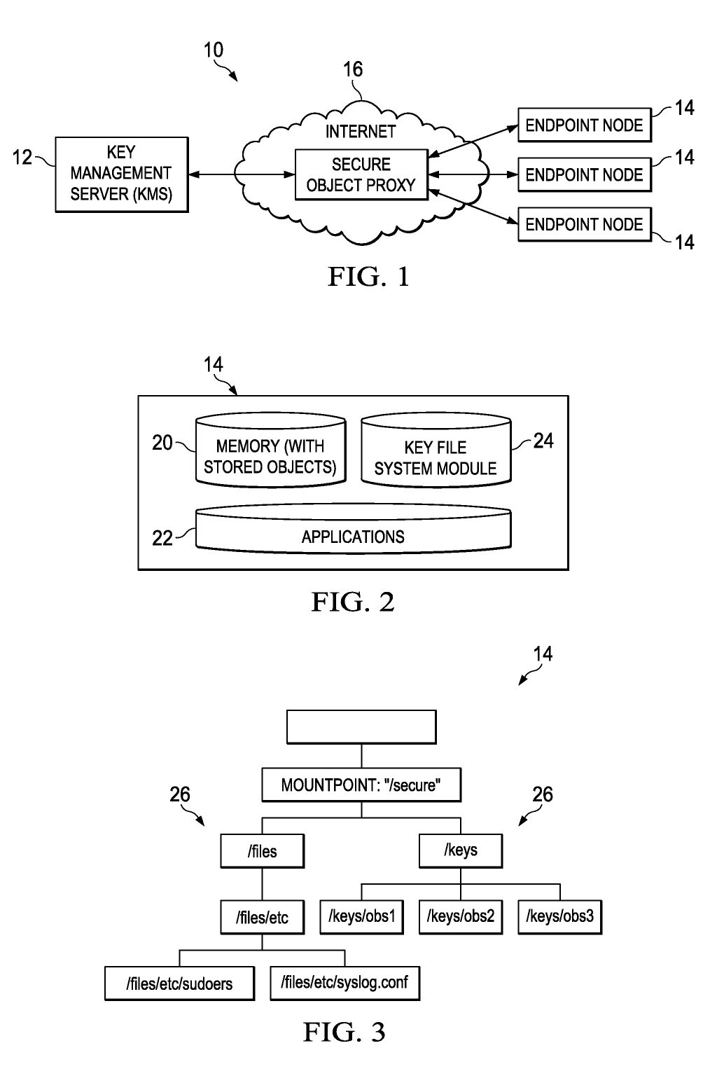

Referring now to FIG. 1, an embodiment file system 10 in a cloud computing environment is illustrated. As shown, the embodiment file system 10 generally includes a key management server (KMS) 12 and a plurality of endpoint nodes 14 communicating through a network 16 (e.g., the Internet). It should be recognized that practical applications of the embodiment file system 10 may include components, devices, hardware, and so on, which have not be been included in FIG. 1 for ease of illustration.

The key management server 12 (a.k.a., central management node, etc.) is generally configured to manage objects (e.g., data files, configuration files, keys, policies, etc.) and to transmit the objects through the network 16 to the endpoint nodes 14. The key management server 12 may be accessed by, for example, a system administrator or a customer. The key management server 12 is configured to implement thread-local storage (TLS), key management interoperability protocol (KMIP), and so on.

In an embodiment, the embodiment file system 10 may also include a secure object proxy server 18 interposed between the key management server 12 and the end point nodes within the network 16. If included in, or used by, the embodiment file management system 10, the secure object proxy server 18 stores all objects in an encrypted or otherwise secure manner. Consistent with the key management server 12, the secure object proxy server 18 is configured to implement thread-local storage (TLS), key management interoperability protocol (KMIP), and so on.

Still referring to FIG. 1, the endpoint nodes 14 (e.g., computers, servers, etc.) are configured to receive objects through the network 16 from the key management server 12 and/or the secure object proxy server 18. The individual cloud endpoint nodes 14 only receive data that they are authorized for and the authorization and object management is done from the key management server 12. While three of the endpoint nodes 14 are illustrated in FIG. 1, it should be recognized that more or fewer of the endpoint nodes 14 may be included in the embodiment file system 10.

Referring now to FIG. 2, one of the endpoint nodes 14 is illustrated in further detail. The endpoint nodes 14 are configured to participate in hypertext transfer protocol secure (HTTPS) and thread-locale storage (TLS) authentication with the key management server 12 and/or the secure object proxy server 18 of FIG. 1. In addition, the endpoint nodes 14 are capable of implementing key management interoperability protocol (KMIP) and so on. As will be more fully explained below, each of the endpoint nodes 14 periodically receives updates through the network 16 from the key management server 12 or proxy server 18.

As shown, the endpoint node 14 includes a memory 20, one or more applications 22 running on the endpoint node 14, and a key file system module 24. It should be recognized that practical applications of the endpoint nodes 14 may include components, devices, hardware, and so on, which have not be been included in FIG. 2 for ease of illustration.

Still referring to FIG. 2, the memory 20 generally stores the objects received by the endpoint node 14. In an embodiment, the objects are stored in the memory 20 by the key file system module 24 to appear to the endpoint node 14 and the applications 22 as a file in a file system structure 26 as shown in FIG. 3. In other words, the key file system module 24 ensures that the objects in the memory 20 are presented to the applications 22 as being in portable operating system interface (POSIX)-compliant file system. As such, the applications 22 are able to access the objects stored in the memory 20 without any knowledge of the underlying distribution or security of the object. Because they are presented as standard files, the applications 22 may attempt to open or read the stored objects using standard operating system (OS) calls.

Referring back to FIG. 2, the key file system module 24 is in communication with the memory 20 and the application 22. The key file system module 24 is configured to enforce a policy when the application 22 requests access to one of the objects stored in the memory 20 corresponding to the policy. In addition, the key file system module 24 applies access controls on sensitive objects using unique policy controls that extend far beyond standard file system access control lists (ACLs). In other words, the key file system module 24 checks at least one policy control or security parameter not included in a standard system access control list (e.g., user identification, group identification, etc.) when the application 22 requests access to the object.

By way of example, the key file system module 24 may perform a check (a.k.a., a script policy check, a permissions check, etc.) in order to assess an additional parameter of the application 22 requesting the object. Such additional parameters may include the name of the application 22 requesting the object in memory 20, the time of day that the application 22 made the request for the object, a type of file, a pathname of an executable allowed to access the object, a command line argument restriction on the executable, and an application 22 of a script in an interpreted language, combinations thereof, and so on.

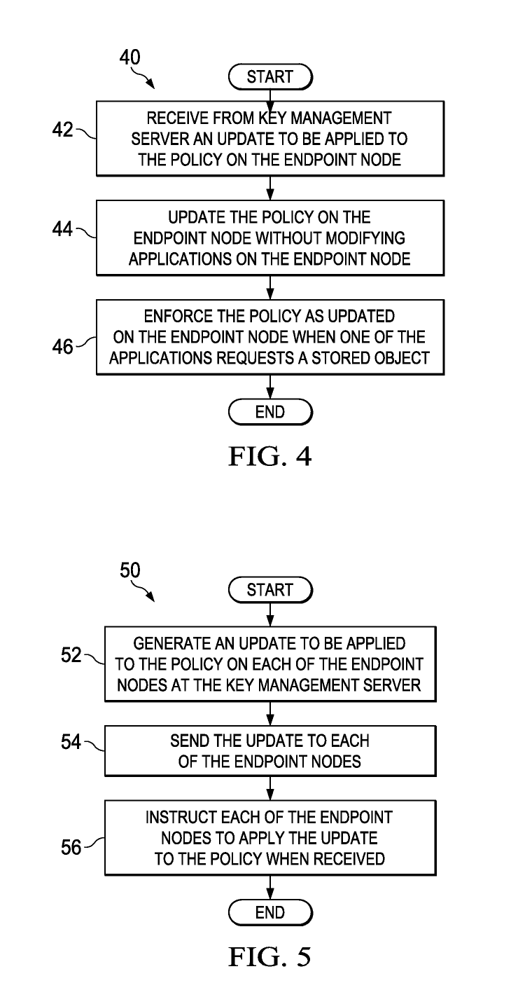

Referring now to FIG. 4, an embodiment method 40 of updating a policy on the endpoint node 14 is illustrated. In block 42, an update to be applied to the policy on the endpoint node is received from the key management server 12. In an embodiment, the configurable updates are received periodically, pursuant to a predetermined schedule, at various unscheduled times, and so on. In block 44, the policy is updated on the endpoint node without modifying applications on the endpoint node. In block 46, the policy as updated is enforced on the endpoint node when one of the applications requests an object stored on the endpoint node.

Referring now to FIG. 5, an embodiment method 50 of updating a policy on a plurality of the endpoint nodes 14 is illustrated. In block 52, an update to be applied to the policy on each of the plurality of endpoint nodes 14 is generated at the key management server 12. For example, an administrator or the customer with access to the key management server 12 may prepare the update. In block 54, the update is sent by the key management server 12 to each of the plurality of endpoint nodes 14. In block 56, each of the plurality of endpoint nodes 14 is instructed by the key management server 12 to apply the update to the policy.

From the foregoing, it should be recognized that the key file system module 24 and/or the file system 10 allows for flexible policies to be written and enforced, which gives administrators greater flexibility in how access to sensitive objects (e.g., data) is granted. Moreover, the key file system module 24 and/or the file system 10 enables centralized key management access across all of the endpoint nodes 14 in the cloud network without the applications on the endpoint nodes 14 having to be aware of the key management.

The updates for the policies can be written at a single location, the key management server 12, and then simultaneously pushed out to all of the endpoint nodes 14. In other words, the key file system module 24 on each of the endpoint nodes 14 is able to enforce access control policies using policy attributes that are centrally defined and managed. This is very preferable to having to access each of the endpoint nodes 14 individually to apply policy updates in a one-by-one fashion.

In addition, the key file system module 24 and/or the file system 10 enables the advanced access controls on all managed objects without any modification or alteration to the applications that are or will be attempting to access the stored objects.

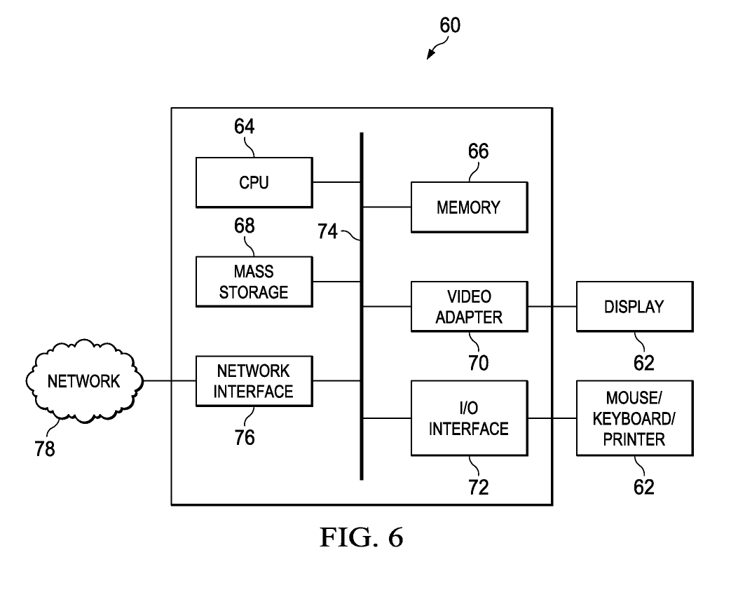

FIG. 6 is a block diagram of a processing system 60 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 60 may comprise a processing unit equipped with one or more input/output devices 62, such as a speaker, microphone, mouse, touchscreen, keypad, keyboard, printer, display, and the like. The processing system 60 may include a central processing unit (CPU) 64, memory 66, a mass storage device 68, a video adapter 70, and an I/O interface 72 connected to a bus 74.

The bus 74 may be one or more of any type of several bus architectures including a memory bus or memory controller, a peripheral bus, video bus, or the like. The CPU 64 may comprise any type of electronic data processor. The memory 66 may comprise any type of system memory such as static random access memory (SRAM), dynamic random access memory (DRAM), synchronous DRAM (SDRAM), read-only memory (ROM), a combination thereof, or the like. In an embodiment, the memory 66 may include ROM for use at boot-up, and DRAM for program and data storage for use while executing programs.

The mass storage 68 device may comprise any type of storage device configured to store data, programs, and other information and to make the data, programs, and other information accessible via the bus 74. The mass storage device 68 may comprise, for example, one or more of a solid state drive, hard disk drive, a magnetic disk drive, an optical disk drive, or the like.

The video adapter 70 and the I/O interface 72 provide interfaces to couple external input and output devices to the processing unit. As illustrated, examples of input and output devices include the display coupled to the video adapter 70 and the mouse/keyboard/printer coupled to the I/O interface 72. Other devices may be coupled to the processing system 60, and additional or fewer interface cards may be utilized. For example, a serial interface such as Universal Serial Bus (USB) (not shown) may be used to provide an interface for a printer.

The processing system 60 also includes one or more network interfaces 76, which may comprise wired links, such as an Ethernet cable or the like, and/or wireless links to access nodes or different networks. The network interface 76 allows the processing system 60 to communicate with remote systems or units via the networks. For example, the network interface 76 may provide wireless communication via one or more transmitters/transmit antennas and one or more receivers/receive antennas. In an embodiment, the processing system 60 (a.k.a., processing unit) is coupled to a local-area network 78 or a wide-area network 78 for data processing and communications with remote devices, such as other processing units, the Internet, remote storage facilities, or the like.

While the disclosure provides illustrative embodiments, this description is not intended to be construed in a limiting sense. Various modifications and combinations of the illustrative embodiments, as well as other embodiments, will be apparent to persons skilled in the art upon reference to the description. It is therefore intended that the appended claims encompass any such modifications or embodiments.

What is claimed is:

1. A method of updating a policy on an endpoint node, comprising:
receiving, from a key management server, an update to be applied to the policy on the endpoint node;
updating, on the endpoint node, the policy without modifying applications on the endpoint node; and
enforcing, on the endpoint node, the policy as updated when one of the applications requests an object stored on the endpoint node.

2. The method of claim 1, further comprising storing, at the endpoint node, the object received from the key management server, the object stored to appear to the endpoint node and the applications as a file in a file system structure.

3. The method of claim 1, further comprising storing, at the endpoint node, the object received from the key management server, the object presented as being in portable operating system interface (POSIX)-compliant file system.

4. The method of claim 1, wherein the enforcing the policy includes checking an identification of the application and at least one additional parameter of the application requesting the object.

5. The method of claim 4, wherein the additional parameter of the application is at least one of a name of the application, a time that the application requested the object, a file type, and a combination thereof.

6. The method of claim 4, wherein the additional parameter of the application is at least one of a pathname of an executable allowed to access the object, a command line argument restriction on the executable, and an application of a script in an interpreted language.

7. The method of claim 1, further comprising permitting the application that requested the object to access the object without the application having knowledge of a distribution of the object.

8. The method of claim 1, further comprising permitting the application that requested the object to access the object without the application having knowledge of a security parameter of the object.

9. The method of claim 1, wherein the update received from the key management server is at least one of routed through a proxy server and routed over a network.

10. The method of claim 1, further comprising receiving, at the endpoint node, objects from the key management server by way of a proxy server, the proxy server storing the objects in an encrypted format.

11. A method of updating a policy on a plurality of endpoint nodes, comprising:
generating, at a key management server, an update to be applied to the policy on each of the plurality of endpoint nodes;
sending, by the key management server, the update to each of the plurality of endpoint nodes; and
instructing, by the key management server, each of the plurality of endpoint nodes to apply the update to the policy when received.

12. The method of claim 11, further comprising simultaneously instructing each of the plurality of endpoint nodes to apply the update to the policy.

13. The method of claim 11, wherein the update to the policy is applied without modifying applications on the endpoint nodes.

14. The method of claim 11, further comprising sending the update to each of the plurality of endpoint nodes through a proxy server.

15. The method of claim 11, further comprising sending the update to each of the plurality of endpoint nodes through a network.

16. The method of claim 11, further comprising sending an object to one of the endpoint nodes to be stored on the endpoint node such that the object appears as a file.

17. An endpoint node, comprising:
a memory storing objects therein, at least one of the objects being a policy;
an application in communication with the memory; and
a key file system module in communication with the memory and the application, the key file system updating the policy in response to a request from a key management server without modifying the application and enforcing the policy as updated when the application requests access to one of the objects stored in the memory corresponding to the policy.

18. The endpoint node of claim 17, wherein the object stored in memory is presented to the application as being in portable operating system interface (POSIX)-compliant file system.

19. The endpoint node of claim 17, wherein the key file system module checks at least one policy control parameter not included in a standard system access control list when the application requests access to the object.

20. The endpoint node of claim 17, wherein the key file system module permits the application that requested the object to access the object without the application having knowledge of a distribution of the object and a security of the object.
